(19) United States
(12) Patent Application Publication
(10) Pub. No.: US 2024/0021340 A1
(43) Pub. Date: Jan. 18, 2024

(54) WIRE HARNESS

(71) Applicant: YAZAKI CORPORATION, Tokyo (JP)

(72) Inventors: Ryo Nagashima, Makinohara-shi (JP); Harutake Satoh, Makinohara-shi (JP)

(21) Appl. No.: 18/336,954

(22) Filed: Jun. 16, 2023

(30) Foreign Application Priority Data
Jul. 13, 2022 (JP) 2022-112721

(51) Int. Cl. H01B 7/00; H01B 7/24

(52) U.S. Cl. CPC H01B 7/0045; H01B 7/24

(57) ABSTRACT

A wire harness includes an electric wire bundle and a branch wire branching off from the electric wire bundle. The electric wire bundle and the branch wire have a tape wound part, in which a tape having a thickness of 0.24 mm or less and a stretch rate of 200% or more in a longitudinal direction is spirally wound around an outer periphery of a predetermined section in a state where a part of the tape in a width direction is wrapped, and an adhesive material applied to a back surface of the tape fixes the electric wire bundle to the tape and fixes the tape to itself. The electric wire bundle and first and second straight portions of the branch wire are bundled by an annular holding tape. A bent portion of the branch wire is provided in the predetermined section.

### CROSS-REFERENCE TO RELATED APPLICATIONS

This application is based on and claims priority under 35 USC 119 from Japanese Patent Application No. 2022-112721 filed on Jul. 13, 2022, the contents of which are incorporated herein by reference.

### TECHNICAL FIELD

The present invention relates to a wire harness mounted on an autonomous vehicle or the like. More particularly, the present invention relates to a wire harness having a tape wound part in which a tape for protecting an electric wire against interference with an external interference member is wound around a necessary part.

### BACKGROUND ART

A wire harness routed in a vehicle has a tape wound part in which a tape for protecting an electric wire against interference with an external interference member such as another component or a vehicle body is wound around a necessary part.

As shown in an example in FIG. 4, in a wire harness WH of this type, a tape TB having an adhesive material applied to a back surface thereof is spirally wound around a predetermined section of an outer periphery of an electric wire bundle W in which a plurality of electric wires Wa are bundled, while a part of the tape TB in a width direction is wrapped. The tape TB is fixed to the tape wound electric wires Wa by the adhesive material applied to the back surface of the tape TB, and is fixed to the tape TB in a lower layer at the wrapped part.

Patent Literature 1 describes an example in which a wear resistant tape made of a fiber-reinforced resin is used as such a protective tape.

### CITATION LIST

### Patent Literature

Patent Literature 1: JP2003-272447A

### SUMMARY OF INVENTION

The tape TB used in the related art has a large thickness, a low stretch rate, and a high rigidity. For this reason, as shown in FIG. 5, when the tape TB is wound and then the wire harness WH is bent according to a routing situation, the tape TB may not follow the bending of the wire harness WH and a part thereof may be peeled off at a bent portion M, and a gap may be formed in a double-wrapped part (portion indicated by TBe in FIG. 5). For this reason, it is considered difficult to use a tape as a protective member at a portion that may be bent during routing.

Further, since the tape used for a wire harness in the related art has a large thickness and a low stretch rate, when the tape is wound around an electric wire having a small diameter, a gap is likely to be formed between the tape and the electric wire, and a portion where the tape is not tightly wound may be formed and the tape may be peeled off. It may be also difficult for a worker to wind a tape having a large thickness and a low stretch rate around an electric wire having a small diameter. For this reason, it is difficult to use a tape for an electric wire having a small diameter.

In particular, in a wire harness in which a branch wire, to which an optional auxiliary device is connected, is branched off from an electric wire bundle, the branch wire may be bent (bent by 180°) to be folded and may be bundled into the electric wire bundle. In this case, the tape may not follow the bending and a part thereof may be peeled off at the bent portion of the branch wire, and a gap may be formed in a double-wrapped part.

The present invention is made in view of the above circumstances, and an object of the present invention is to provide a wire harness having a tape wound part in which, even when an optional branch wire is bent to be folded and is bundled into an electric wire bundle, a tape wound as a protective member around the bent portion of the electric wire would not be peeled off, can follow the bending and be tightly wound around the electric wire of the branch wire, and can safely protect the electric wire, by tape winding, against interference with an external interference member.

In order to achieve the above object, a wire harness according to the present invention has the following features.

A wire harness of the present invention includes an electric wire bundle in which a plurality of electric wires are bundled, and a branch wire constituted by a part of the plurality of electric wires branching off from the electric wire bundle. The branch wire includes a first straight portion extending along a first direction in a longitudinal direction of the electric wire bundle from a branch portion from the electric wire bundle, a bent portion bent in a U-shape from the first straight portion, a second straight portion extending from the bent portion in a second direction in the longitudinal direction of the electric wire bundle, and a connector connected to a tip end of the second straight portion. The electric wire bundle and the branch wire have a tape wound part, in which a tape having a thickness of 0.24 mm or less and a stretch rate of 200% or more in a longitudinal direction is spirally wound around an outer periphery of a predetermined section in a state where a part of the tape in a width direction is wrapped, and an adhesive material applied to a back surface of the tape fixes the electric wire bundle or an exterior member thereof to the tape and fixes the tape to itself. The electric wire bundle, the first straight portion, and the second straight portion are bundled by an annular holding tape, and the bent portion of the branch wire is provided in the predetermined section.

According to the present invention, it is possible to provide a wire harness having a tape wound part in which, even when an optional branch wire is bent to be folded and is bundled into an electric wire bundle, a tape wound as a protective member around the bent portion of the electric wire would not be peeled off, can follow the bending and be tightly wound around the electric wire of the branch wire, and can safely protect the electric wire, by tape winding, against interference with an external interference member.

The present invention is briefly described above. Details of the present invention can be further clarified by reading modes (hereinafter referred to as “embodiments”) described later for carrying out the invention with reference to the accompanying drawings.

### BRIEF DESCRIPTION OF DRAWINGS

FIG. 1 shows a wire harness according to an embodiment of the present invention;

FIG. 2 shows a wire harness according to a reference example;

FIG. 3 shows a state in which a branch wire of the wire harness according to the reference example protrudes;

FIG. 4 shows a wire harness in the related art in a state before tape winding; and

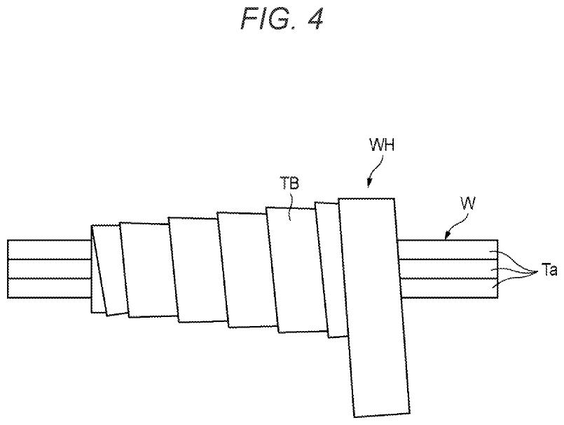

FIG. 5 shows the wire harness in the related art in a state after tape winding.

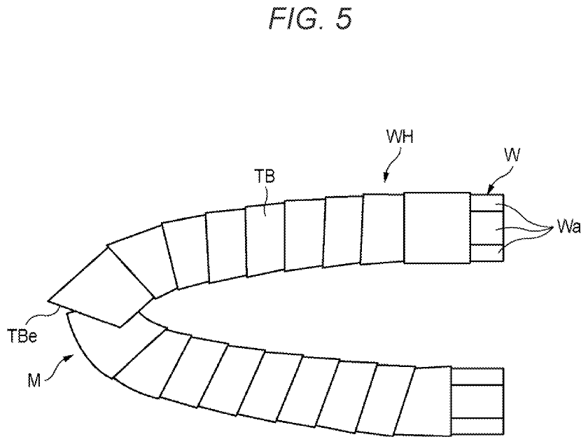

### DESCRIPTION OF EMBODIMENTS

Specific embodiments of the present invention will be described below with reference to the drawings.

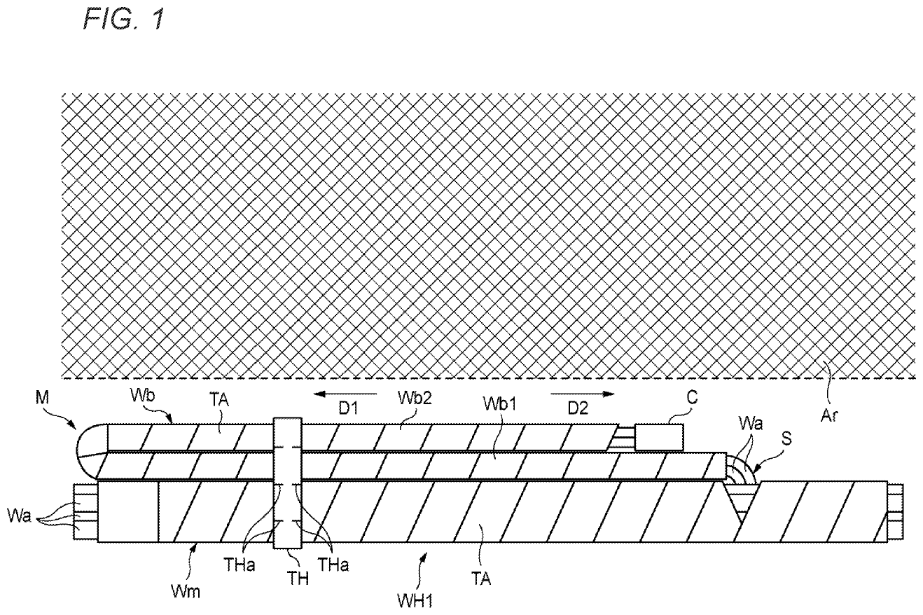

FIG. 1 shows a wire harness according to an embodiment of the present invention.

As shown in FIG. 1, a wire harness WH1 in the present embodiment includes an electric wire bundle Wm and a branch wire Wb.

The electric wire bundle Wm is a bundle of a plurality of electric wires Wa, and the branch wire Wb is constituted by a part of the electric wires Wa branched off from the electric wire bundle Wm. The branch wire Wb is branched off from the electric wire bundle Wm at a branch portion S.

The branch wire Wb includes a first straight portion Wb1, a bent portion M, a second straight portion Wb2, and a connector C.

The first straight portion Wb1 extends along one direction D1 as a first direction in a longitudinal direction of the electric wire bundle Wm from the branch portion S from the electric wire bundle Wm. The bent portion M is bent in a U-shape from the first straight portion Wb1. The second straight portion Wb2 extends from the bent portion M in the other direction D2 as a second direction in the longitudinal direction of the electric wire bundle Wm. The connector C is connected to a tip end of the second straight portion Wb2. The first straight portion Wb1 and the second straight portion Wb2 are arranged side by side along the electric wire bundle Wm.

On the wire harness WH1, a polyvinyl chloride tape (PVC tape) TA having a thickness of 0.24 mm or less and a stretch rate of 200% or more in a longitudinal direction is wound around an outer periphery of a predetermined section (part that may interfere with an external interference member) of the electric wire bundle Wm and the branch wire Wb. The PVC tape TA more preferably has a stretch rate of 300% or more.

In the present embodiment, the PVC tape TA is wound in a state in which substantially half of the PVC tape TA, which is a part thereof in a width direction, is wrapped and this state is referred to as half wrapping. An adhesive material is applied (including stuck) to an entire back surface of the tape TA in advance. The adhesive material fixes the electric wire bundle Wm to the tape TA, the branch wire Wb to the tape TA, and the tape TA to itself (tapes in the wrapped part). By wrapping the tape TA, a part around which the tape TA is wound becomes double winding having a large thickness (0.48 mm), and a protection function equivalent to that in a case where the part is covered with a tube (thickness of substantially 0.5 mm) is obtained.

In the wire harness WH1, a part including the predetermined section around which the PVC tape TA is wound is a tape wound part, and the bent portion M of the branch wire Wb is provided in the predetermined section.

In the wire harness WH1, the electric wire bundle Wm, the first straight portion Wb1, and the second straight portion Wb2 are bundled by an annular holding tape TH in the predetermined section that is the tape wound part. The holding tape TH has cuts THa in both side portions. The cuts THa are provided at intervals in a circumferential direction of the holding tape TH. The cuts THa are provided in the same positions in the circumferential direction respectively in both side portions of the holding tape TH. Accordingly, the holding tape TH has a reduced width in positions where the cuts THa are provided.

In the wire harness WH1, the first straight portion Wb1 and the second straight portion Wb2 of the branch wire Wb are arranged tightly along the electric wire bundle Wm, and can thus be routed in an area outside a route restriction area Ar where routing is restricted due to a risk of interference with an external interference member.

In the wire harness WH1, an optional auxiliary device is connected to the connector C provided at the tip end of the second straight portion Wb2 of the branch wire Wb. That is, the branch wire Wb of the wire harness WH1 constitutes wiring for an optional connection circuit to which the optional auxiliary device, which is mounted on a vehicle as an optional device as necessary, is connected.

When the optional auxiliary device is connected to the branch wire Wb, the holding tape TH bundling the electric wire bundle Wm, the first straight portion Wb1, and the second straight portion Wb2 of the wire harness WH1 is peeled off, and the first straight portion Wb1 and the second straight portion Wb2 arranged along the electric wire bundle Wm are extended and wired. At this time, the holding tape TH can be easily cut off and removed since the holding tape TH has the cuts THa, and the bundling of the branch wire Wb to the electric wire bundle Wm by the holding tape TH can be released.

Next, a reference example will be described.

The same components as those of the above-described embodiment are denoted by the same reference numerals, and description thereof is omitted.

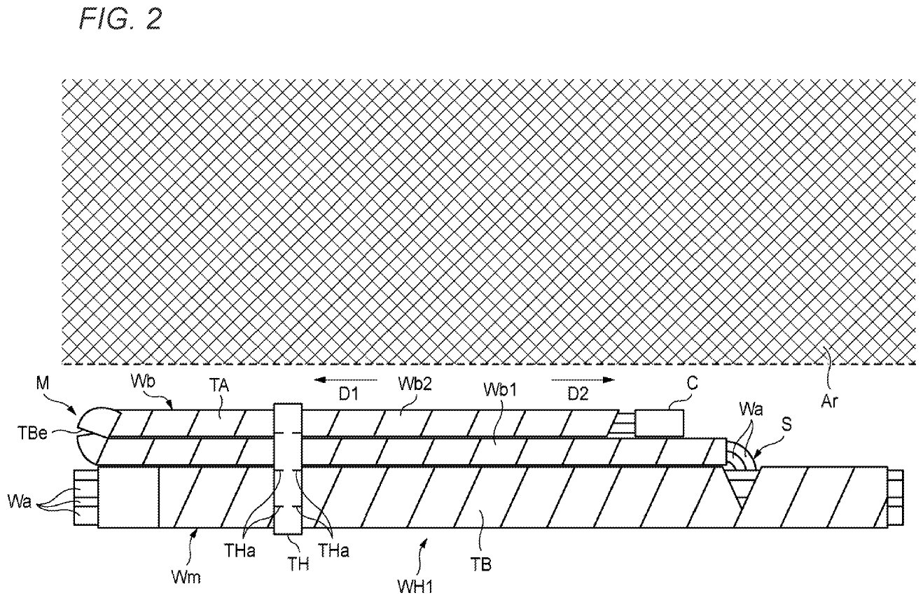

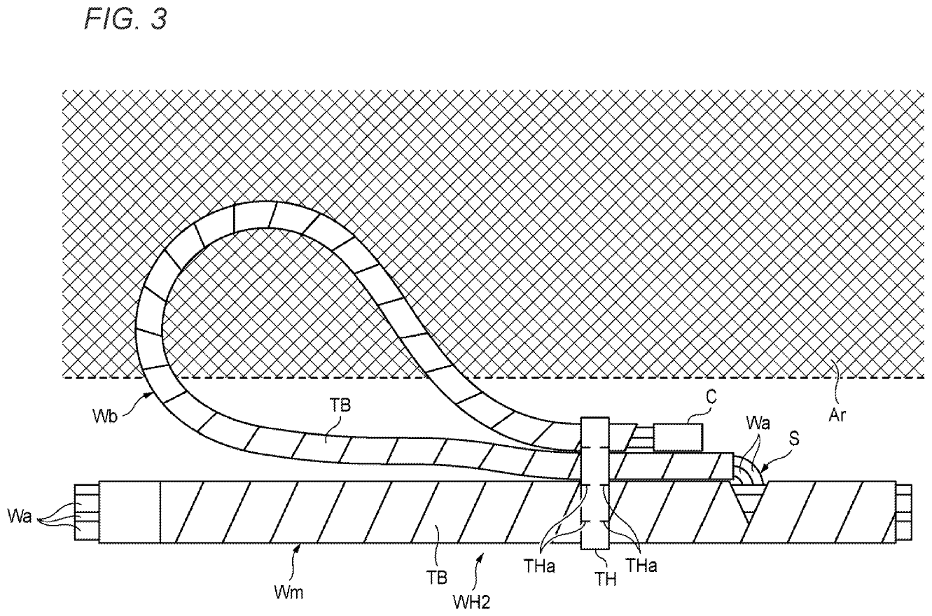

FIG. 2 shows a wire harness according to the reference example. FIG. 3 shows a state in which a branch wire of the wire harness according to the reference example protrudes.

As shown in FIG. 2, in a wire harness WH2 according to the reference example, a polyvinyl chloride tape (PVC tape) TB is wound around an outer periphery of a predetermined section (part that may interfere with an external interference member) of the electric wire bundle Wm and the branch wire Wb. The tape TB used in the wire harness WH2 according to the reference example has a thickness of 0.3 mm, a low stretch rate, and a high rigidity.

For this reason, at the bent portion M of the branch wire Wb, the tape TB does not follow the bending of the branch wire Wb and a part thereof is peeled off (portion indicated by TBe in FIG. 3), and a gap is formed in a double-wrapped part. As shown in FIG. 3, to prevent peeling of the tape TB from the branch wire Wb, the branch wire Wb is curved by bringing a bundling portion by the holding tape TH close to the branch portion S. At this time, the branch wire Wb enters the route restriction area Ar, making routing difficult to perform.

In contrast, according to the wire harness WH1 in the present embodiment, the tape TA spirally wound around the outer periphery of the predetermined section of the electric wire bundle Wm and the branch wire Wb has a thickness of 0.24 mm or less and a stretch rate of 200% or more in the longitudinal direction. When the tape TA is used, the peeling due to floating of the tape TA is prevented even at the bent portion where the electric wires Wa have a large curvature. Accordingly, the branch wire Wb having the U-shaped bent portion M can be bundled tightly with the electric wire bundle Wm without peeling of the tape TA. Accordingly, routing space of the wire harness WH1 having the branch wire Wb can be reduced, and wiring can be easily performed in a manner that the branch wire Wb does not enter the route restriction area Ar. That is, the number of positions where the wire harness WH1 can be routed is increased.

In this manner, according to the wire harness WH1, the PVC tape TA having a thickness of 0.24 mm or less and a stretch rate of 200% or more in the longitudinal direction is wound around the outer periphery of the electric wire bundle Wm and the branch wire Wb in a section where there is risk of interference due to an external interference member. Accordingly, the electric wires Wa in the tape wound part can be protected against interference due to the external interference member. Further, the tape TA has a small thickness and is stretched. Accordingly, even at the bent portion M of the branch wire Wb that is bent in a U-shape, the tape TA can follow the bending of the electric wires Wa while maintaining a reliably tight state, and a gap due to the peeling of the tape TA can be prevented.

Since the small-thickness and stretched tape TA is used, tightness of the tape TA to the electric wires Wa (electric wire bundle Wm, branch wire Wb) can be maintained even when the electric wires Wa (electric wire bundle Wm, branch wire Wb) have a small diameter, and the tape TA would not be peeled off. Accordingly, in the section in which the tape TA is wound, the tape TA can be tightly wound around the outer periphery of the branch wire Wb having a diameter smaller than a diameter of the electric wire bundle Wm, similar to the other sections. For this reason, tape peeling and a gap due to tape peeling can be prevented. When winding the tape TA around the branch wire Wb having a small diameter, a worker can fix one end of the tape TA to the electric wires Wa, and then wind the tape TA around the electric wires Wa while stretching the tape TA. Accordingly, a tape can be wound around the electric wires Wa having a small diameter around which a worker could not wind a tape by hand in the related art.

As a result, the present invention can be applied to a wire harness in which a protection target portion is bent at the time of routing and a wire harness in which a portion where an electric wire or an electric wire bundle has a small diameter is provided at a protection target portion, which were difficult to perform protection by tape winding. Accordingly, the predetermined section of the wire harness WH1 in which tape winding could not be performed and the electric wire was protected by, for example, installing a protector, a corrugated tube and the like in the related art can be replaced with the protection by tape winding, and the cost can be greatly reduced. Even when specifications of the wire harness WH1 are changed, it is possible to cope with the change simply by changing a tape winding position by the worker without changing design of the protector or the corrugated tube. Further, an exterior member such as a protector or a corrugated tube molded by a mold has a size that can cope with electric wire bundles having various diameters, and thus a wire harness has an increased diameter. Since the protection target portion by the protector or the corrugated tube can be protected by the tape TA, the diameter of the wire harness can be reduced.

When attention is paid to only a protection function for the wire harness WH1, tape winding with a fabric tape having a large thickness is also considered. However, such a fabric tape cannot be cut off by the worker by hand, and it is necessary to prepare a tape cut off at a predetermined length in advance or to cut off the tape by a cutter or the like every time the worker winds the tape, resulting in a remarkable decrease in efficiency. In contrast, since the PVC tape TA in the present embodiment can be cut off by the worker by hand, the wire harness WH1 can be protected while maintaining work efficiency.

A thickness of a tape needs to be equal to or less than 0.24 mm and equal to or more than a thickness that can satisfy the protection function required for the wire harness WH1. The thickness of the PVC tape TA may be selected in accordance with assumed curvature of the wire harness WH1 within such a range of the thickness of the tape.

In the wire harness WH1, a protector made of resin may be sheathed in the middle of the electric wire bundle Wm in which a plurality of electric wires Wa are bundled. In this case, the PVC tape TA, that is, the PVC tape TA having a thickness of 0.24 mm or less and a stretch rate of 200% or more in the longitudinal direction is wound around a part of the protector and the electric wire bundle Wm while being overlapped with an appropriate wrap margin.

In this manner, the protector and the electric wires Wa (electric wire bundle Wm) can be reliably bundled with the tape TA, and a lead-out portion of the electric wires Wa (electric wire bundle Wm) from the protector can be protected against interference with an external interference member.

The present invention is not limited to the above-described embodiments and can be appropriately modified, improved and the like. In addition, materials, shapes, sizes, numbers, arrangement positions and the like of components in the above-described embodiments are freely selected and are not limited as long as the present invention can be implemented.

Here, features of the embodiments of the wire harness according to the present invention described above are briefly summarized and listed in the following [1] to [3].

[1] A wire harness (WH1) includes an electric wire bundle (Wm) in which a plurality of electric wires (Wa) are bundled and a branch wire (Wb) constituted by a part of the plurality of electric wires (Wa) branching off from the electric wire bundle (Wm). The branch wire (Wb) includes a first straight portion (Wb1) extending along one direction (D1) in a longitudinal direction of the electric wire bundle (Wm) from a branch portion (S) from the electric wire bundle (Wm), a bent portion (M) bent in a U-shape from the first straight portion (Wb1), a second straight portion (Wb2) extending from the bent portion (M) in the other direction (D2) in the longitudinal direction of the electric wire bundle (Wm), and a connector (C) connected to a tip end of the second straight portion (Wb2). The one direction is opposite to the other direction. The electric wire bundle (Wm) and the branch wire (Wb) have a tape wound part, in which a tape (TA) having a thickness of 0.24 mm or less and a stretch rate of 200% or more in a longitudinal direction is spirally wound around an outer periphery of a predetermined section in a state where a part of the tape (TA) in a width direction is wrapped, and an adhesive material applied to a back surface of the tape (TA) fixes the electric wire bundle (Wm) or an exterior material thereof to the tape (TA) and fixes the tape (TA) to itself. The electric wire bundle (Wm), the first straight portion (Wb1), and the second straight portion (Wb2) are bundled by an annular holding tape (TH). The bent portion (M) of the branch wire (Wb) is provided in the predetermined section.

According to the wire harness having the configuration of the above [1], the tape spirally wound around the outer periphery of the predetermined section of the electric wire bundle and the branch wire has a thickness of 0.24 mm or less and a stretch rate of 200% or more in the longitudinal direction. When the tape is used, the peeling due to floating of the tape is prevented even at the bent portion where the electric wires have a large curvature. Accordingly, the branch wire having the U-shaped bent portion can be bundled tightly with the electric wire bundle without peeling of the tape. Accordingly, it is possible to reduce routing space of the wire harness having the branch wire and increase the number of positions where the wire harness can be routed.

[2] In the wire harness according to [1], the holding tape (TH) has a cut (THa) in a width direction.

According to the wire harness having the configuration of the above [2], the annular holding tape bundling the electric wire bundle, the first straight portion, and the second straight portion has a cut. Accordingly, the holding tape can be easily cut off and removed, and the bundling of the branch wire to the electric wire bundle by the holding tape can be released.

[3] In the wire harness according to [1] or [2], the connector (C) of the branch wire (Wb) is connected to an optional auxiliary device.

According to the wire harness having the configuration of the above [3], the holding tape is removed as necessary and the branch wire is wired, and the optional auxiliary device is connected to the connector of the branch wire to increase a function. When the option is not used, the branch wire can be compactly accommodated in the routing space in a state of being bundled to the electric wire bundle.

What is claimed is:

1. A wire harness comprising:
an electric wire bundle in which a plurality of electric wires are bundled; and
a branch wire constituted by a part of the plurality of electric wires branching off from the electric wire bundle, wherein
the branch wire includes
a first straight portion extending along a first direction in a longitudinal direction of the electric wire bundle from a branch portion from the electric wire bundle,
a bent portion bent in a U-shape from the first straight portion,
a second straight portion extending from the bent portion in a second direction in the longitudinal direction of the electric wire bundle, and
a connector connected to a tip end of the second straight portion,
the electric wire bundle and the branch wire have a tape wound part, in which a tape having a thickness of 0.24 mm or less and a stretch rate of 200% or more in a longitudinal direction is spirally wound around an outer periphery of a predetermined section in a state where a part of the tape in a width direction is wrapped, and an adhesive material applied to a back surface of the tape fixes the electric wire bundle or an exterior member thereof bundle to the tape and fixes the tape to itself,
the electric wire bundle, the first straight portion, and the second straight portion are bundled by an annular holding tape, and
the bent portion of the branch wire is provided in the predetermined section.

2. The wire harness according to claim 1, wherein
the holding tape has a cut in a width direction.

3. The wire harness according to claim 1, wherein
the connector of the branch wire is connected to an optional auxiliary device.
